(19) United States
(12) Patent Application Publication
(10) Pub. No.: US 2026/0081388 A1
(43) Pub. Date: Mar. 19, 2026

(54) SHIELD CONNECTOR

(71) Applicant: Yazaki Corporation, Tokyo (JP)

(72) Inventors: Kuninori Matsubara, Shizuoka (JP); Sota Kawarasaki, Shizuoka (JP); Jun Sugioka, Shizuoka (JP)

(73) Assignee: Yazaki Corporation, Tokyo (JP)

(21) Appl. No.: 19/329,655

(22) Filed: Sep. 16, 2025

(30) Foreign Application Priority Data
Sep. 17, 2024 (JP) 2024-160007

(51) Int. Cl. H01R 13/6593; B60L 53/16; H01R 13/6589; H01R 13/74

(52) U.S. Cl. CPC H01R 13/6593; B60L 53/16; H01R 13/6589; H01R 13/743; H01R 2201/26

(57) ABSTRACT

A shield connector includes a second shell attached at a position opposite to a first shell with a part of a housing interposed between the first shell and the second shell. The second shell has a wire holding portion that holds four wires led out toward a leading-out direction between the first shell and the second shell. The wire holding portion has four housing grooves that are formed toward a position where the four wires are bundled, and each houses one of the four wires such that the four wires are spaced apart from one another along a first direction. Two of the four housing grooves form regulatory grooves. The regulatory groove includes a first portion formed along a leading-out direction, and a second portion that is a portion formed to be slanted with respect to the leading-out direction.

### CROSS-REFERENCE TO RELATED APPLICATION(S)

The present application claims priority to and incorporates by reference the entire contents of Japanese Patent Application No. 2024-160007 filed in Japan on Sep. 17, 2024.

### BACKGROUND OF THE INVENTION

### 1. Field of the Invention

The present invention relates to a shield connector.

### 2. Description of the Related Art

An example of conventional shield connectors includes a lower shell and an upper shell that are assembled to a housing in which wires are assembled to regulate the positions of the wires. In such a shield connector, the wires are bundled while a distance is maintained that takes into account interference between the wires and the lower shell (e.g., refer to Japanese Patent Application Laid-open No. JP 2017-157 392 A).

The conventional shield connector, in which the positions of multiple wires are regulated by assembling the lower shell and the upper shell, however, causes the wires to tend to interfere with the lower shell due to the regulation. There is thus room for improvement.

### SUMMARY OF THE INVENTION

The present invention aims to provide a shield connector that can properly prevent interference between shells and wires.

In order to achieve the above mentioned object, a shield connector according to one aspect of the present invention includes a housing that holds a plurality of terminals provided on ends of wires; a first shell that is attached to the housing; and a second shell that is attached at a position opposite to the first shell with a part of the housing interposed between the first shell and the second shell, wherein one of the first shell and the second shell has a wire holding portion that interposes and holds the wires led out from the housing toward a leading-out direction of the wires between the first shell and the second shell, the wire holding portion has a plurality of housing grooves that are formed toward a position where the wires led out from the housing are bundled, and each of the housing grooves houses one of the wires such that the wires are spaced apart from one another along a first direction orthogonal to the leading-out direction, and at least one of the housing grooves forms a regulatory groove that includes: a first portion formed along the leading-out direction when viewed from a second direction orthogonal to the leading-out direction and the first direction; and a second portion that is a portion formed to be slanted with respect to the leading-out direction and formed to be slanted in the first direction from an end side of the wire holding portion toward a center side of the wire holding portion in the first direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating a schematic configuration of a shield connector according to an embodiment;

FIG. 2 is a cross-sectional view illustrating an internal structure of the shield connector in FIG. 1;

FIG. 3 is an exploded perspective view of a housing, an upper shell, and a lower shell that are included in the shield connector in FIG. 1; and

FIG. 4 is a plan view illustrating a schematic configuration of the lower shell in FIG. 3.

### DETAILED DESCRIPTION OF THE PREFERRED EMBODIMENTS

The following describes an embodiment of the invention in detail with reference to the drawings. The invention is not limited by the following embodiment. The components in the following embodiment include those that can be readily assumed by those skilled in the art or those that are substantially the same components. Various omission, replacement, and modification of the components can be made without departing from the gist of the invention.

In the following explanation with reference to the figures, the X direction is referred to as the “first direction X,” the Y direction is referred to as the “second direction Y,” and the Z direction is referred to as the “leading-out direction Z”. Here, “the first direction X”, “the second direction Y”, and “the leading-out direction Z” are orthogonal to one another. The first direction X corresponds to the width direction of a shield connector 1, and the arrangement direction of a plurality of wires W, for example. The second direction Y corresponds to the insertion/extraction direction (mating direction) between the shield connector 1 and the mating connector, and the front-back direction (thickness direction) of the shield connector 1, for example. One side in the second direction Y is referred to as the “insertion direction Y1” and the other side is referred to as the “extraction direction Y2”. The leading-out direction Z corresponds to the height direction (up-down direction) of the shield connector 1, the extending direction of the wires W, and the inserting direction of the wires W with respect to the shield connector 1, for example. One side in the leading-out direction Z is referred to as the “upward direction Z1” and the other side is referred to as the “downward direction Z2” of the wires W. Unless otherwise noted, each direction used in the following explanation shall represent the direction in which the components are assembled with each other.

### Embodiment

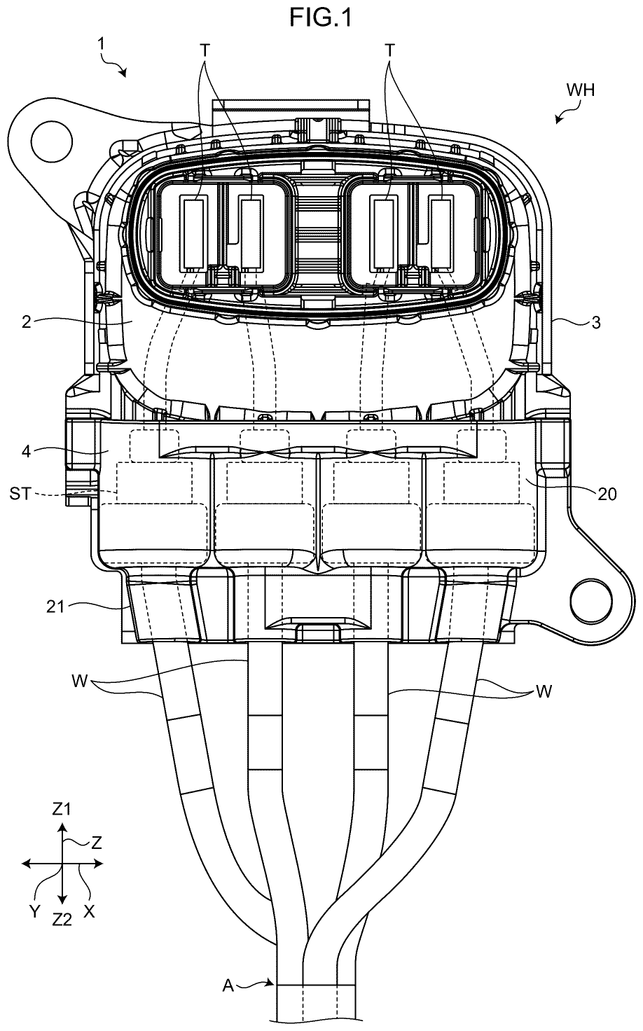

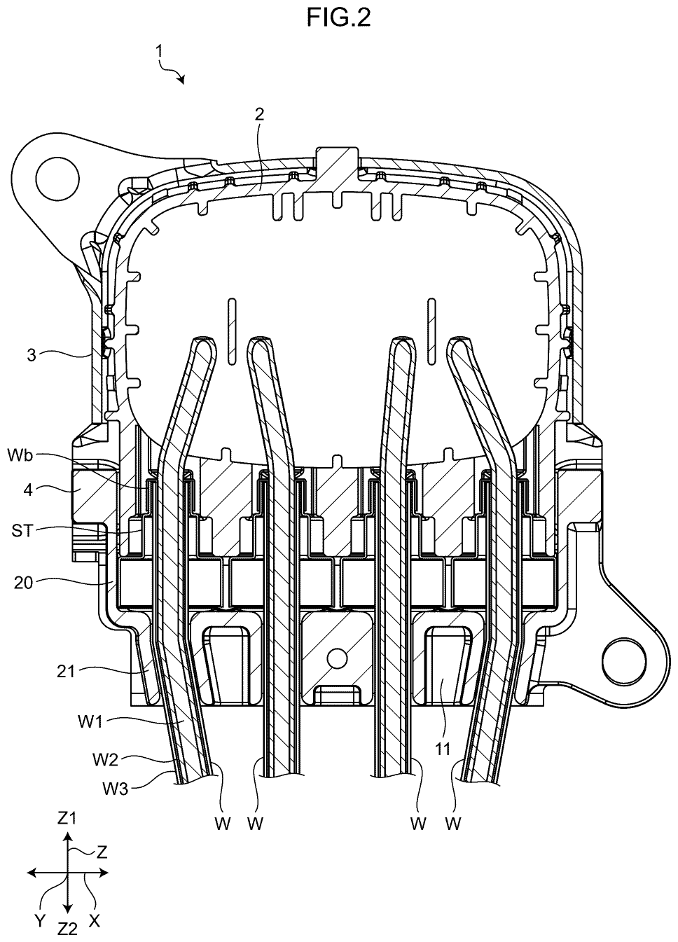

FIG. 1 is a plan view illustrating a schematic configuration of the shield connector according to the embodiment. FIG. 2 is a cross-sectional view illustrating an internal structure of the shield connector in FIG. 1.

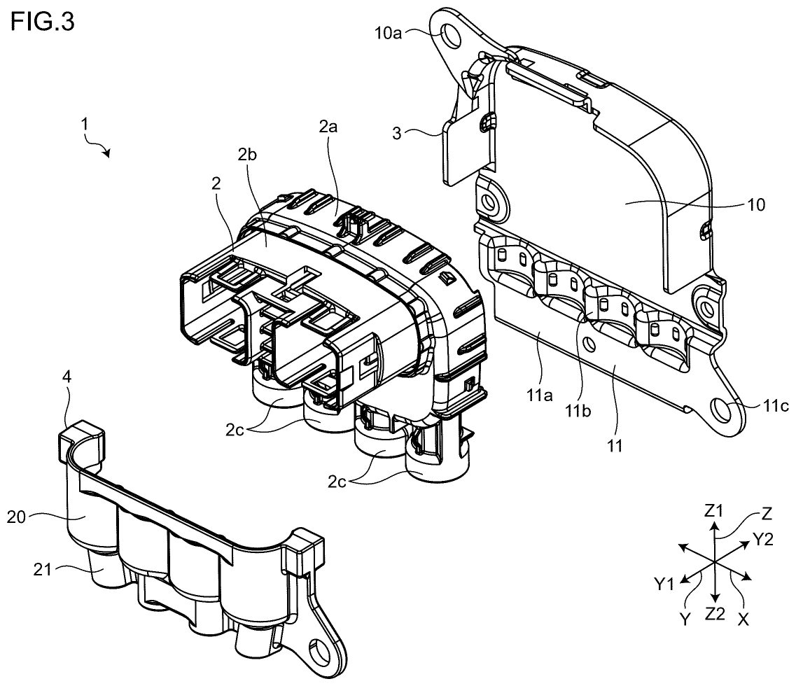

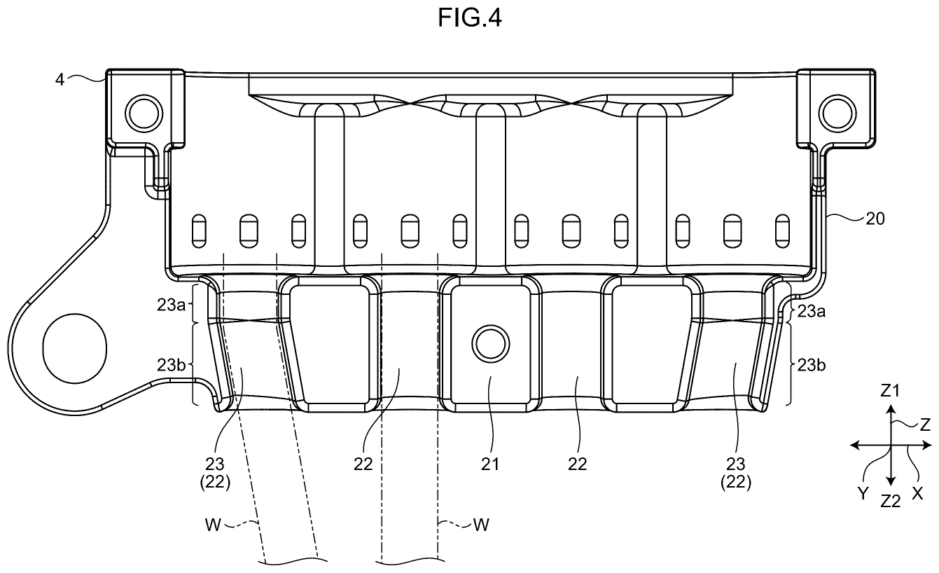

FIG. 3 is an exploded perspective view of a housing, an upper shell, and a lower shell that are included in the shield connector in FIG. 1. FIG. 4 is a plan view illustrating a schematic configuration of the lower shell in FIG. 3.

The shield connector 1 illustrated in FIG. 1 is built into a wire harness WH that is routed into a vehicle, such as an automobile. The wire harness WH is used for connecting each of the devices mounted in the vehicle with the shield connector 1 that connects, to the corresponding device, a plurality of wires W that are used for power supply and signal communication, and bundled as a collective component, for example.

The wire harness WH includes the wires W, a plurality of terminals T each of which is provided to one of the ends of the wires W, and the shield connector 1 that houses and holds the terminals T. The wire harness WH may further include various components such as grommets, electrical junction boxes, and fixtures.

The wires W are routed into the vehicle to establish electrical connection among the devices. The wire W is a shielded wire, for example. As illustrated in FIG. 2, the wire W includes a core wire W1, an inner covering W2, a braided body Wb, which is a shield layer, and an outer covering W3, which is a sheath.

The core wire W1 is made of a conductive material and is a part performing the function that the wire W is required to fulfill (e.g., signal transmission and reception, and power supply). The inner covering W2 is made of an insulating material such as a synthetic resin and covers the core wire W1 to establish insulation between the core wire W1 and the braided body Wb. The braided body Wb is a conductive metal (e.g., copper or aluminum) member that covers the inner covering W2. The braided body Wb prevents penetration and leakage of electromagnetic waves, electric fields, and magnetic fields, and enhances the reliability of communication with the core wire W1. The outer covering W3, which is the outermost covering of the wire W, prevents external damage to the inner member and water ingress into the interior. The external covering W3, which is also called an external insulator, is made of an insulating material.

The terminal T is electrically connected to the wire W, and to which a conductive mating terminal (not illustrated) is connected. The mating terminal is formed of a conductive metal material, for example, and to which terminal T can be connected. The mating terminal is housed and held in the mating connector (not illustrated). The mating connector is the fitting target of the shield connector 1 and is provided in the device mounted in the vehicle. The terminal T is housed and held in the shield connector 1 along the second direction Y. The embodiment exemplifies a case in which the shield connector 1 is a male connector and the mating connector is a female connector. The embodiment, however, is not limited to this example.

The shield connector 1 includes a housing 2, a first shell 3, a second shell 4, and shield terminals ST.

The housing 2 houses and holds the terminals T provided on the ends of the wires W. The housing 2 is formed to be capable of holding four terminals T spaced along the first direction X. The housing 2 has a housing body 2a, a cylindrical portion 2b, and wire insertion portions 2c. The housing body 2a, the cylindrical portion 2b, and the wire insertion portions 2c are integrally formed from a synthetic resin material having an insulating property.

The housing body 2a has openings formed on both sides in the second direction Y, for example. When the terminals T are housed in the cylindrical portion 2b, the terminals T are exposed to the outside through the opening on the insertion direction Y1 side of the housing body 2a while the opening on the extraction direction Y2 side of the housing body 2a is closed by the first shell 3. The housing body 2a is formed in a substantially rectangular shape as viewed from the second direction Y, for example. The housing body 2a has a plurality of wire insertion portions 2c at the end of the housing body 2a on the downward direction Z2 side.

The cylindrical portion 2b is provided to the housing body 2a and projects cylindrically from the housing body 2a toward one side (mating connector side) in the second direction Y. The cylindrical portion 2b fits with the mating connector.

Through the wire insertion portion 2c, the wire W is inserted. The wire insertion portions 2c are formed to project from the end of the housing body 2a on the downward direction Z2 side toward the downward direction Z2 side. The wire insertion portion 2c is formed in a cylindrical shape. The wire W is routed along the inside of the wire insertion portion 2c in the leading-out direction Z. In other words, the housing body 2a holds the terminals T along the second direction Y, and allows the wires W to be drawn out along the leading-out direction Z, which is orthogonal to the second direction Y. In this example, the housing body 2a is provided with four wire insertion portions 2c aligned in the first direction X, and each of the wires W is inserted into one of the four wire insertion portions 2c.

The first shell 3, which is what is called an upper shell, is attached to the housing 2. The first shell 3 covers the periphery of the terminals T and wires W in the housing 2 to prevent noise generated from the wires W from leaking outside the shield connector 1. As illustrated in FIG. 3, the first shell 3 forms what is called a shield shell in combination with the second shell 4. The first shell 3 is formed from a conductive metal material, for example. The first shell 3 includes a first shell body 10 and a cover portion 11.

The first shell body 10 is tub-shaped to cover the extraction direction Y2 side of the housing 2. In other words, the first shell body 10 has a housing space that is open toward one side in the second direction Y and houses a part of the housing body 2a. The first shell body 10 has a through hole 10a through which a bolt (not illustrated) is inserted along the second direction Y. The shield connector 1 is fixed, with the bolt inserted through the through hole 10a, to the device or the like (not illustrated) in which the mating connector is provided.

The cover portion 11 covers and simultaneously interposes the four wires W and the four shield terminals ST held in a wire holding portion 21, which is described later, between the second shell 4 and the first shell 3 when the first shell 3 is attached to the housing 2. The cover portion 11 has a flat surface 11a, a shield terminal holding portion 11b, and a through hole 11c. The flat surface 11a is formed to be extended along the first direction X. The shield terminal holding portion 11b holds the four shield terminals ST at once. The through hole 11c is formed in a portion projecting from one end of the flat surface 11a in the first direction X when the cover portion 11 is viewed from the insertion direction Y1, and penetrates the portion in the second direction Y.

The second shell 4, which is what is called a lower shell, is attached at a position opposite to the first shell 3 with a part of the housing 2 interposed between the second shell 4 and the first shell 3. The second shell 4 covers the periphery of the terminals T and wires W in the housing 2 to prevent noise generated from the wires W from leaking outside the shield connector 1. The second shell 4 is formed from a conductive metal material, for example. The second shell 4 includes a second shell body 20 and the wire holding portion 21.

The second shell body 20 is formed in a groove shape to hold the shield terminals ST each of which is connected to one of the four wires W and to cover the four wire insertion portions 2c on the housing 2 side. The wire holding portion 21 is connected to the end of the second shell body 20 on the downward direction Z2 side.

The wire holding portion 21 interposes and holds the four wires W that are led out from the housing 2 toward the leading-out direction Z of the wires W between the first shell 3 and the second shell 4. The wire holding portion 21 has four housing grooves 22 as illustrated in FIG. 4. The housing grooves 22 each house and hold one of the wires W inside thereof. The housing grooves 22 are formed toward a position A where the multiple wires W led out from the housing 2 are bundled. The position A in the embodiment is located in the downward direction Z2 apart from the end of the wire holding portion 21 on the downward direction Z2 side. At the position A, the four wires W are bundled (refer to FIG. 1). In the downward direction Z2 below the position A, the four wires W are bundled in an outer material such as a taping member or corrugated tube. The four housing grooves 22 of the wire holding portion 21 each house one of the four wires W such that the wires W are spaced apart from one another along the first direction X, as illustrated in FIG. 4. Of the four housing grooves 22, the two housing grooves 22 on both sides in the first direction X each form a regulatory groove 23.

The regulatory groove 23 regulates the direction of the wire W that is led out from the shield connector 1 to the outside. The regulatory groove 23 includes a first portion 23a and a second portion 23b. The first portion 23a is formed on the second shell body 20 side in the regulatory groove 23, and is connected to the second shell body 20. The first portion 23a is formed in a straight line shape along the leading-out direction Z when viewed from the second direction Y. The second portion 23b is formed on the downward direction Z2 side relative to the first portion 23a in the regulatory groove 23, and is connected to the first portion 23a. The second portion 23b is a portion formed to be slanted with respect to the leading-out direction Z and formed to be slanted in the first direction X from the end side toward the center side of the wire holding portion 21 in the first direction X. The housing grooves 22 other than the housing grooves 22 that form the regulatory grooves 23, i.e., the two housing grooves 22 on the center side, each do not have the second portion 23b formed to be slanted with respect to the leading-out direction Z. The two housing grooves 22 on the center side are formed, as a whole, in a straight line shape along the leading-out direction Z.

The shield terminal ST is a conductive member such as metal, for example, and is formed in a cylindrical shape. The shield terminal ST is electrically connected to the braided body Wb and is electrically connected to the first shell 3 and the second shell 4 when the first shell 3 and the second shell 4 are assembled to the housing 2.

The following describes assembly of the first shell 3 and the second shell 4 to the housing 2. In the embodiment, four terminals T are housed and held in the housing 2.

An assembly operator assembles the second shell 4 to the housing 2. At this time, the operator houses the shield terminals ST each connected to one of the wires W in the second shell body 20, and also houses the wires W in the corresponding housing grooves 22 and regulatory grooves 23. Then, the operator assembles and fixes the first shell 3 to the housing 2 to which the second shell 4 has been assembled.

In an example of conventional shield connectors, each of the four housing grooves is formed in a straight line shape along the leading-out direction Z. In this case, in a case where the position A where the four wires W are bundled is close to the shield connector 1, respective two wires W disposed on both sides in the first direction X among the four wires W may interfere with the second shell, when the first shell and the second shell are assembled to the housing 2. In other words, as the number of wires W increases due to a multipole configuration, respective wires W disposed on both sides in the first direction more likely interfere with the second shell when the multiple wires W are bundled.

The shield connector 1 in this embodiment thus has the regulatory grooves 23, which are two of the four housing grooves 22 of the wire holding portion 21. The regulatory grooves 23 each have the first portion 23a formed along the leading-out direction Z and the second portion 23b formed to be slanted from the end side toward the center side of the wire holding portion 21 in the first direction X. In comparison with the regulatory groove 23 entirely formed with the second portion 23b, forming the first portion 23a makes it possible to eliminate the effect of the slant of the wire W inside the connector and to prevent interference between the wire W and the second shell even when the position A where the wires W are bundled is close to the shield connector 1.

As explained above, the shield connector 1 in the embodiment includes the housing 2, the first shell 3 attached to the housing 2, and the second shell 4 attached at a position opposite to the first shell 3 with a part of the housing 2 interposed between the first shell 3 and the second shell 4. The second shell 4 has the wire holding portion 21 that interposes and holds four wires W led out from the housing 2 toward the leading-out direction Z between the first shell 3 and the second shell 4. The wire holding portion 21 has four housing grooves 22 that are formed toward the position A where the four wires W led out from the housing 2 are bundled, and each house one of the four wires W such that the four wires W are spaced apart from one another along the first direction X. Two of the four housing grooves 22 form the regulatory grooves 23. The regulatory groove 23 includes the first portion 23a formed along the leading-out direction Z, and the second portion 23b that is a portion formed to be slanted with respect to the leading-out direction Z and formed to be slanted from the end side toward the center side of the wire holding portion 21 in the first direction X.

In comparison with the conventional shield connectors, the above configuration enables the shield connector 1 to properly prevent interference between the first shell 3 and the wires W and between the second shell 4 and the wires W when the first shell 3 and the second shell 4 are assembled to regulate the positions of the four wires W. In comparison with the shield connector having the regulatory grooves 23 entirely formed with the first portions 23a, the shield connector 1, which has the second portions 23b partially included in the regulatory grooves 23, enables the four wires W to follow the slant of the wires W, the slant being formed when the four wires W are bundled. As a result, the shield connector 1 makes it possible to locate the position A where the wires W are bundled closer to the shield connector 1 than a case where the position A is kept away from the shield connector 1, thereby making it possible to downsize the wire harness WH.

The shield connector 1 has the regulatory grooves 23 disposed in the housing grooves 22 on both sides in the first direction X among the four housing grooves 22. This enables the shield connector 1 to cause the wires W that are each led out from one of the housing grooves at both ends in the first direction X in the four housing grooves to be slanted from the end side toward the center side of the wire holding portion in the first direction X. As a result, the shield connector 1 makes it possible to locate the position A where the wires W are bundled closer to the shield connector 1.

The shield connector 1 in the embodiment includes the second shell 4 having the wire holding portion 21. The embodiment is, however, not limited to the example. For example, the first shell 3 may have the wire holding portion 21.

In the shield connector 1 in the embodiment, the housing grooves 22 other than the housing grooves 22 serving as the regulatory grooves 23, i.e., the two housing grooves 22 on the center side, do not have any second portion 23b and are formed, as a whole, in a straight line shape along the leading-out direction Z. The embodiment is, however, not limited to this example. For example, the two housing grooves 22 on the center side in the shield connector 1 may each also have a portion corresponding to the second portion 23b. In the embodiment, the regulatory grooves 23 are disposed on both sides in the first direction X. The arrangement are, however, not limited to this example. The regulatory groove 23 may be disposed on either one side in the first direction X.

In the embodiment, the shield connector 1 houses four wires W. The number of wires W is, however, not limited to this number.

In the embodiment, the invention is applied to the shield connector 1. The invention may be applied to connectors other than the shield connectors.

The shield connector according to the embodiment can properly prevent interference between the shells and the wires.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A shield connector comprising:
a housing that holds a plurality of terminals provided on ends of wires;
a first shell that is attached to the housing; and
a second shell that is attached at a position opposite to the first shell with a part of the housing interposed between the first shell and the second shell, wherein
one of the first shell and the second shell has a wire holding portion that interposes and holds the wires led out from the housing toward a leading-out direction of the wires between the first shell and the second shell,
the wire holding portion has a plurality of housing grooves that are formed toward a position where the wires led out from the housing are bundled, and each of the housing grooves houses one of the wires such that the wires are spaced apart from one another along a first direction orthogonal to the leading-out direction, and
at least one of the housing grooves forms a regulatory groove that includes:
a first portion formed along the leading-out direction when viewed from a second direction orthogonal to the leading-out direction and the first direction; and
a second portion that is a portion formed to be slanted with respect to the leading-out direction and formed to be slanted in the first direction from an end side of the wire holding portion toward a center side of the wire holding portion in the first direction.

2. The shield connector according to claim 1, wherein
the regulatory groove is disposed in each of the housing grooves at least on both sides in the first direction among the housing grooves.
